(19) United States
(12) Patent Application Publication
(10) Pub. No.: US 2024/0300227 A1
(43) Pub. Date: Sep. 12, 2024

(54) LOW EMISSIVITY ROOFING UNDERLAYMENT

(71) Applicant: ROBERT DANIEL RUSSELL, Fort Worth, TX (US)

(72) Inventor: ROBERT DANIEL RUSSELL, Fort Worth, TX (US)

(21) Appl. No.: 18/600,200

(22) Filed: Mar. 8, 2024

Related U.S. Application Data
(60) Provisional application No. 63/450,944, filed on Mar. 8, 2023.

(51) Int. Cl. B32B 27/12; B32B 5/02; B32B 5/26; B32B 27/32; E04D 12/00

(52) U.S. Cl. CPC B32B 27/12; B32B 5/024; B32B 5/028; B32B 5/262; B32B 27/32; E04D 12/002; B32B 2255/10; B32B 2255/205; B32B 2255/26; B32B 2262/0253; B32B 2270/00; B32B 2307/416; B32B 2307/7246; B32B 2307/7265; B32B 2307/744; B32B 2419/06

(57) ABSTRACT

A low-emissivity roofing underlayment comprises a woven reinforcing substrate sandwiched between an aluminized bottom layer and a slip resistant top layer. The bottom, aluminized layer is adapted to be placed against the roof sheathing, facing inward toward the roof rafters, and the slip resistant top layer faces outward and may be walked on by roof shingle installers with a decreased risk of slip and fall accidents, thus permitting safer walking during construction of steeper roofs.

### CROSS REFERENCE TO RELATED APPLICATION(S)

This application claims domestic benefit from U.S. Provisional Application Ser. No. 63/450,944, filed Mar. 8, 2023, which is incorporated by reference herein in its entirety.

### BACKGROUND OF THE INVENTION

### 1. Field of the Invention

This invention relates generally to thermal insulating means for buildings, and particularly to such means for roofing materials. More particularly, this invention relates to an aluminized and slip resistant underlayment for placement between roofing shingles and roof sheathing to provide both a moisture and a low emissivity heat barrier.

### 2. Description of Related Art

Roof surfaces for buildings encounter direct radiation from the sun. Particularly in summer, and especially in more southerly climes, such solar radiation can be intense. Roofing materials exhibit varying degrees of ability to fend off such solar radiation, depending upon factors such as the composition, color and thickness of the top layer of roofing materials. Roofs that are most successful are said to be thermally reflective, conductively deterrent and to have high emissivity.

Emissivity is the opposite of reflectivity. A high emissivity material embodies high absorptance, while materials with lower emissivity emit less radiant heat, but also reflect or scatter more light. All thermally opaque materials are in some part emissive, and some part reflective. Quantitatively, emissivity is the ratio of the energy radiated from a material's surface to that radiated from a perfect emitter, known as a blackbody. It is a dimensionless number between zero (0.00) for a perfect reflector and one (1.00) for a perfect emitter.

In practical terms, shingle roofing performs well on this scale, but it can always be improved. Darker shingles absorb more thermal radiation and are less reflective than lighter colored shingles. Even light colored shingles, however, absorb significant quantities of heat. Thus, the ability of a roof, including the shingles, to dissipate absorbed heat (not reflected by the shingle coloration) and thereby not to conduct such absorbed heat into the building, depends in large part upon the roof's aggregate emissivity.

Roofing materials are selected to serve a variety of purposes, emissivity being only one. Shingle durability, weight, aesthetic attractiveness and ease of installation are taken into account when a builder selects the shingles for a given roof. Some shingles employed may more emissive than others because another factor, such as price, was more important to the builder. A need exists to provide the builder greater flexibility in shingle selection while maintaining as low a level of roof emissivity as practicable.

A roof underlayment comprises a membrane placed atop the roof sheathing, or decking. Underlayments seal the decking and render the roof as leak-proof as practicable. Underlayments come in two types: felt/asphault sheeting and synthetic materials. Felt underlayments are less expensive than synthetic materials, but synthetic materials are reputed to provide a better moisture barrier. Underlayment typically is supplied in approximately 3- to 4-foot wide rolls and laid horizontally across the decking in overlapping tiers.

Roofing installation can be hazardous for the installer. A large number of installers are injured and killed by falls from sloping roofs, especially those with steeper pitches. Further, not all roof surfaces are easy to walk on. Some underlayments, such as asphault felt, are inherently tacky and have a higher coefficient of friction, while others, particularly synthetics, are noticebly less so. A need exists for an underlayment which abets the safety of an installer walking upon previously installed underlayment while installing additional underlayment tiers and shingles.

Some prior art underlayments address this safety issue by providing a texturized top layer that increases friction between the underlayment and the installer's shoes. Such texturizing, however, can increase weight of the underlayment, and accordingly the roof, because the texturized layer must necessarily be thicker than otherwise. A need exists for a tacky, high-friction, slip resistant top surface for shingle roof underlayments.

### SUMMARY OF THE INVENTION

A low-emissivity roofing underlayment comprises a woven reinforcing substrate sandwiched between an aluminized bottom layer and a slip resistant top layer. The bottom, aluminized layer is adapted to be placed against the roof sheathing, facing inward toward the roof rafters, and the slip resistant top layer faces outward and may be walked on by roof shingle installers with a decreased risk of slip and fall accidents, thus permitting safer walking during construction of steeper roofs.

### BRIEF DESCRIPTION OF THE DRAWINGS

The novel features believed characteristic of the present invention may be set forth in appended claims. The invention itself, as well as a preferred mode of use and further objects and advantages thereof, will best be understood by reference to the following detailed description of an illustrative embodiment when read in conjunction with the accompanying drawings, wherein:

FIG. 1 shows a concept diagram of how materials impacted by heat sources handle the resulting heat.

FIG. 2 shows a typical roof with wooden decking, synthetic underlayment and asphault shingles.

FIG. 3 illustrates the component layers of the underlayment that is the present invention.

FIG. 4 illustrates a test report of the coefficient of friction for the anti-skid, slip-resistent underlayment of the present invention.

### DESCRIPTION OF A PREFERRED EMBODIMENT

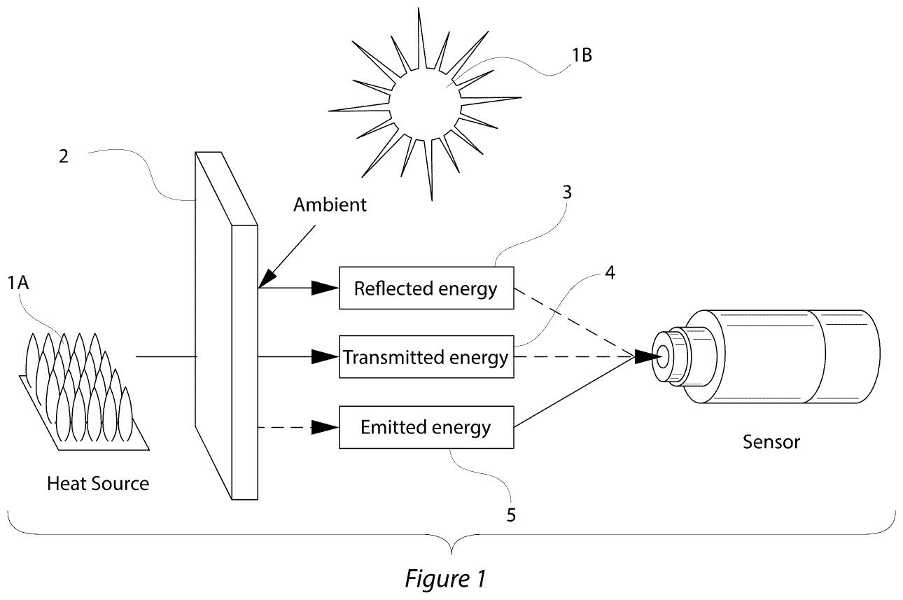

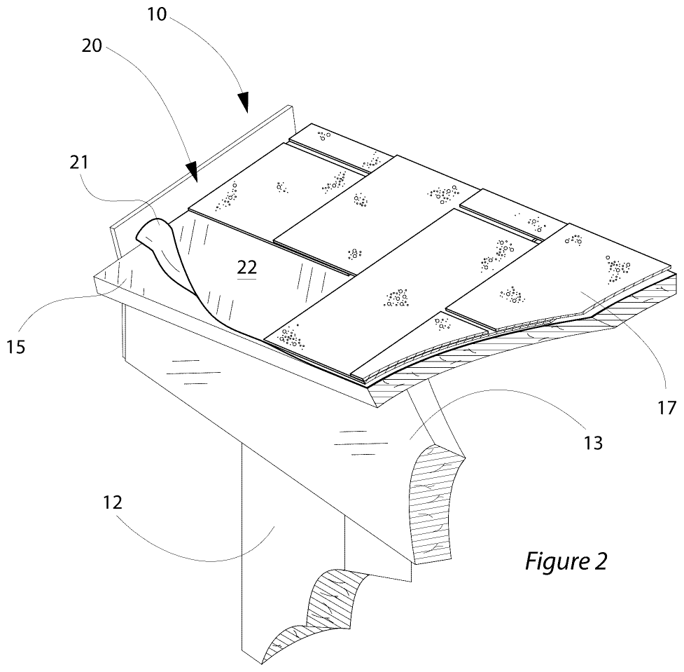

Referring now to the figures, and particularly to FIGS. 1-2, a portion of heat incident upon roof 11 (FIG. 2) is transmitted through the roof into a building space. Target 2 represents an idealized roof material incurring incident sunlight and concomitant alternate heat sources 1A, 1B. As illustrated, some of incident sunlight radiation 1B is reflected 2 off the surface rather than being absorbed. A second heat source 1A on the opposite side of target 2 emits heat that is conducted, or transmitted 4, right through target 2. Obviously, the more thermally absorbent target 2 is, the less heat energy is reflected, the balance being absorbed into target 2's material. Similarly, the more efficient target 2 is at deterring transmitted heat (i.e. it's insulating capacity), the less heat from source 1A is absorbed. No insulation is 100% efficient, however, so some of the heat from sources 1A, 1B will be absorbed.

Emitted energy 5 comes from a material's absorbed energy. For the portions of incident heat that get through target 2 and into building 10 (FIG. 2), emitted heat is the heat which is absorbed and not reflected and then transmitted into building 10. The factor that quantifies this emitted heat is the emissivity of target 2. Thus, the lower the emissivity factor for target 2, the better it protects building 10 from incident external heat sources.

Roof 10 comprises sheath decking 15 atop roof rafters 13 and supported by building components 12. Shingles 17 comprise the top layer of roof 10, which receives incident solar radiation 1B, as well as other environmental conditions such as rain, snow, hail and the like (none depicted). Shingles 17 comprise asphalt rectangles bearing a granular, high-friction upper surface commonly provided with “tabs” to simulate shake shingles (not shown). One having ordinary skill in the art will recognize that shingles 17 could be simpler tabbed rectangles or even roll roofing without departing from the scope of the present invention. As illustrated, shingles 17 are laid in staggered, horizontal tiers, though such tiers do not necessarily correspond to the tiers mentioned herein above for underlayments.

Underlayment 20 of the present invention is shown installed between decking 15 and shingles 17, a portion of underlayment 20 being curled upwards to reveal its lower, or inner surface 21 opposite its upper, or outer surface 22. As discussed above, underlayment 20 will have been provided, probably in rolls, and installed in horizontal tiers (neither shown) prior to installing shingles 17. Bottom surface 21 covers sheathing 15 to provide a moisture barrier that deters moisture getting through shingles 17 from reaching sheathing 15 and leading to long-term deterioration of sheathing 15, rafters 13 and eventually building 12.

### Structure

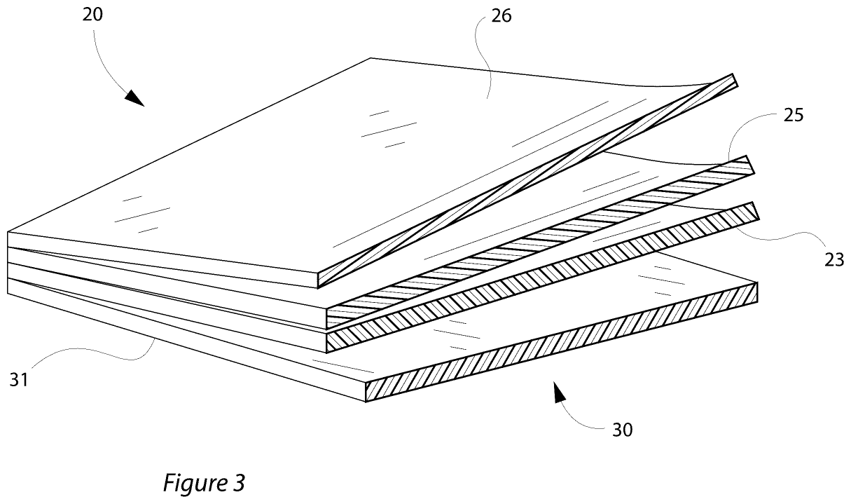

Turning now also to FIG. 3, underlayment 20 comprises a reinforcing layer, or “scrim” 23 adapted sandwiched between surface layers 26, 31. Scrim 23 provides strength to the remaining layers and resists tearing or other damage during installation or usage. Atop scrim 23, top surface 22 is composed of a flexible web 26 bearing on one side an anti-slip coating and laminated onto scrim 23. In some cases, such as where scrim 23 does not provide waterproofing functionality, a waterproofing layer 25 may lie between web 26 and scrim 23. One having ordinary skill in the art will be aware that many underlayments include only scrim 23 and waterproofing layer 25, without providing more. The present invention, however, not only includes anti-slip layer 26, but also low emissivity layer 30 between scrim 23 and sheathing 15.

Low emissivity layer 30 comprises another flexible web 31 similar to web 26 but bearing on its lower surface 33 a coating of aluminum, rendering web 31 reflective to radiated heat energy. Incident heat from inside building 10 and transmitted through sheating 15 by conduction encounters aluminized web 31 and is reflected back through sheath 15 and into building 10, thus conserving heat energy in cold weather times. Incident heat from outside building 10, as illustrated above in relation to FIG. 1, is emitted from shingles 17 toward building 10, but encounters aluminized web 31 and is reflected back through underlayment 20 and into shingles 17, where shingles 17 further conduct it into the air above roof 11. Said another way, underlayment 20 having low-emissivity/high-reflectivity layer 30 in the form of aluminized web 31, lowers the overall emissivity of roof 11.

### Anti-Slip Surface

Top surface 22 of underlayment 20 remains exposed to the environment until shingles 17 are installed. During the installation process (not shown), installers must walk upon top surface 22 while installing shingles 17. The more slip-resistant top surface 22 is, the safer it is for the installers to do so, especially on roofs with steep slopes. As discussed in more detail below, top surface 22 is coated with a tacky substance which significantly increases the coefficient of friction of top surface 22, thus increasing safety for installers while they install shingles 17 and other roof devices (not shown).

### Example

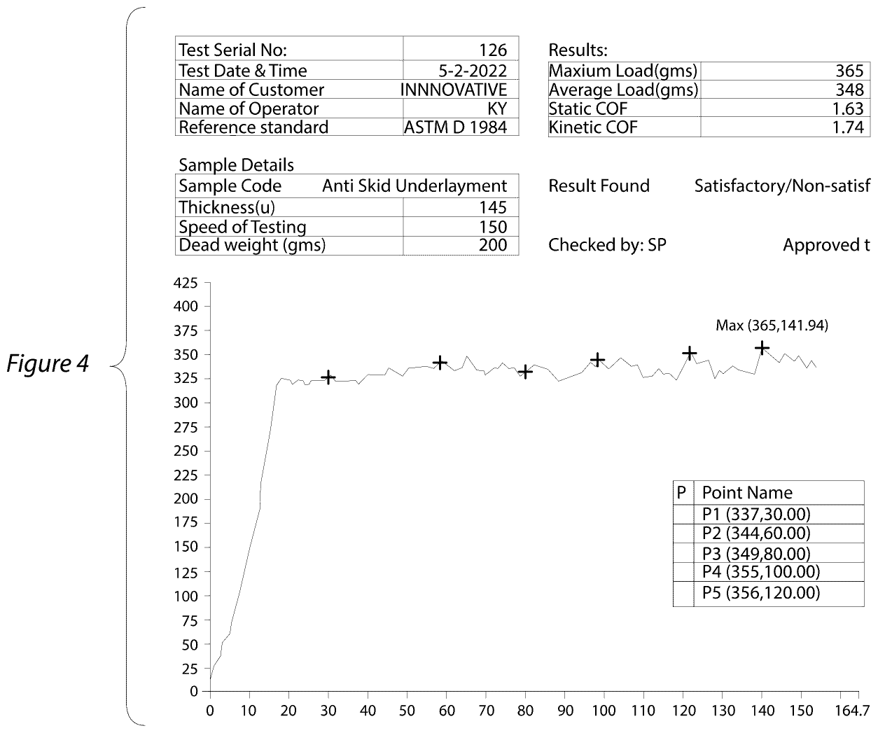

Referring now also to FIG. 4, an independent testing agency analyzed the present invention in light of Reference standard ASTM D 1894 for plastic film and sheeting. The test method measures initial and moving friction while a loaded sled is dragged across a test plane onto which the test material has been placed. The test determines both static (initial) and kinetic (moving) coefficients of friction (COF) across horizontal displacement of the sled across the test plane. FIG. 4 show that, on May 2, 2022, the COF of the present invention rose rapidly to a plateau approximating 325 then maintained COF across the remaining 150 inches of displacement, reaching a maximum at 365 grams at 141.94 just short of maximum displacement of 150.

### Manufacturing

Underlayment 20 preferably comprises a reinforcing web layer, or scrim 23 of woven fabric or other strong substrate laminated on one side to a reflective layer and on the other side to an anti-slip coating. In a particular embodiment, the roofing underlayment may include a 0.1%-2% by weight UV Agent and 10-20% by weight terpolymer of ethylene, methacrylic acid, and acrylate.

In another particular embodiment, the reflective layer comprises metalized substrate such as polyester or other form of substrate, and in more particularly, a twelve (12) micron layer of aluminum-coated polyester.

In another particular embodiment, scrim 23, is a woven polyethylene web comprising preferably fifty-five (55) grams per square meter (GSM) of HDPE. In another particular embodiment, scrim layer 23 has a core layer comprising 2% UV Master Batch, 10% Nucrel AE, 8% Grey Master Batch, 80% low density poly-ethylene (LDPE).

In another particular embodiment, anti-slip coating web 26 comprises ethylene vinyl acetate (EVA) copolymer. In still another particular embodiment, web 26 comprises 30%-50% by weight EVA copolymer, and 0-50% by weight LDPE resin. In yet another particular embodiment, web 26 EVA copolymer is LG EVA EA28025. Still further, anti-slip web 26 preferably comprises a layer of EVA copolymer laminated by extrusion coating methods onto a substrate of low density polyethylene (LDPE). Still more preferably, web 26 comprises 30%-50% by weight EVA copolymer on a fifty (50%) percent by weight LDPE. Still more preferably, the LDPE is blended at a rate of 0.1% to 2% by weight with a ultraviolet (UV) resistance agent. Low emissivity layer 30 comprises a metalized polyester.

In another particular embodiment, anti-slip web 26 further comprises a skin coating layer and a core layer. The core layer may comprise 2% UV Master Batch, the lower coating layer comprises 73.5% thermoplastic olefin resin, 8.0% LDPE, 2% UV Master Batch, 8% Grey Master Batch, and 60% EVA copolymer of LG EVA EA28025.

A LDPE layer is available as Nucrel AE from Dow Chemical of Midland, Michigan USA. A suitable EVA copolymer is available as LG EVA EA28025 from LG Chemical, Ltd. of Seoul, South Korea.

Web 26 and reflective layer 31 preferably may be co-extruded onto scrim 23. The first upper layer comprises 40% by weight of the upper coating layer and the second upper layer comprises 60% by weight of the upper coating layer. The first upper layer preferably comprises 70% by weight of the upper coating layer and said second upper layer comprises 30% by weight of the upper coating layer.

Melt temperature range of the upper coating layer preferably falls between 450° F. to 550° F. Chill roll temperatures vary between 45° F. and 85° F. The whole Process is finished in one single operation on a CO EX Tandem Extrusion Lamination, comprising 2 Screw Barrels on Each Traction. Mpet PE Fabric coating is done on Traction 1. EVA-LDPE anti-slip coating is done on Traction 2.

### SUMMARY

While the invention has been particularly shown and described with reference to preferred and alternate embodiments, it will be understood by those skilled in the art that various changes in form and detail may be made therein without departing from the scope of the invention. For example, though webs 26, 31 have been specified above as comprising polyethylene, other materials such as polypropylene can be substituted insofar as they can be laminated onto scrim 23 as described.

I claim:

1. A low-emissivity roofing underlayment for placement between a building roof deck and roof shingles atop said roof deck, said underlayment comprising
a scrim layer having a top scrim surface and a bottom scrim surface;
a slip-resistant layer disposed on said top scrim layer; and
a reflective layer disposed on said bottom scrim layer.

2. The roofing underlayment of claim 1 and further comprising
a waterproofing layer disposed between said scrim layer and said slip-resistant layer.

3. The roofing underlayment of claim 1 and wherein said scrim layer comprises
reinforcing means for providing structural strength and geometric stability to said scrim layer; and
moisture barrier means for providing a barrier to moisture between said roof deck and said shingles.

4. The roofing underlayment of claim 3 wherein said reinforcing means comprises
a web of woven high-density polyethylene (HDPE). woven polypropylene.

5. The roofing underlayment of claim 4 wherein said web of high-density polyethylene (HDPE) comprises
woven polypropylene.

6. The roofing underlayment of claim 3 wherein said moisture barrier means comprises
73.5% thermoplastic olefin resin and 8.0% low density polyethylene.

7. The roofing underlayment of claim 3 and further comprising
a 0.1%-2% by weight ultraviolet (UV) resistant agent and 10-20% by weight terpolymer of ethylene, methacrylic acid, and acrylate.

8. The roofing underlayment of claim 1 wherein said slip-resistant layer comprises
a flexible web of high-density polyethylene (HDPE) having a proximate web surface laminated onto said top scrim surface and a distal web surface bearing an anti-slip coating.

9. The roofing underlayment of claim 8 and wherein said anti-slip coating comprises
a layer of ethylene vinyl acetate (EVA) copolymer extruded onto a substrate of low density polyethylene (LDPE).

10. The roofing underlayment of claim 9 and wherein
said layer of ethylene vinyl acetate (EVA) comprises between thirty (30%) percent and fifty (50%) percent by weight ethylene vinyl acetate (EVA); and
said substrate of low density polyethylene (LDPE) comprises between zero (0%) percent and fifty (50%) percent by weight low-density polyethylene (LDPE).

11. The roofing underlayment of claim 1 wherein said reflective layer comprises
a flexible web of high-density polyethylene (HDPE) having a proximate web surface laminated onto said bottom scrim surface and a distal web surface bearing a coating of aluminum.

12. A method of manufacturing a low-emissivity roof underlayment comprising
providing a scrim layer having a top scrim surface and a bottom scrim surface; and
providing an anti-slip layer having a proximate anti-slip surface; then
extruding said anti-slip layer onto said scrim layer with said proximate anti-slip surface adjacent said top scrim surface.

13. The method of claim 12 and further comprising
providing a waterproofing layer; then
extruding said waterproofing layer onto said top scrim surface between said scrim layer and said anti-slip layer.
